(19) United States
(12) Patent Application Publication
(10) Pub. No.: US 2019/0220209 A1
(43) Pub. Date: Jul. 18, 2019

(54) INFORMATION PROCESSING APPARATUS, METHOD FOR CONTROL, AND NON-TRANSITORY COMPUTER-READABLE RECORDING MEDIUM HAVING STORED THEREIN CONTROL PROGRAM

(71) Applicant: FUJITSU LIMITED, Kawasaki-shi (JP)

(72) Inventors: Yoshimasa MISHUKU, Yokohama (JP); Goro Yamada, Adachi (JP); Yutaro Hiraoka, Kawasaki (JP); Masaki Takeuchi, Kawasaki (JP)

(73) Assignee: FUJITSU LIMITED, Kawasaki-shi (JP)

(21) Appl. No.: 16/226,710

(22) Filed: Dec. 20, 2018

(30) Foreign Application Priority Data
Jan. 15, 2018 (JP) 2018-004323

(51) Int. Cl. G06F 3/06

(52) U.S. Cl. CPC G06F 3/0637; G06F 3/067; G06F 3/0604; G06F 3/0634

(57) ABSTRACT

An information processing apparatus includes a memory; a processor coupled to the memory; and one or more resources, the processor being configured to allow a plurality of the processes to be performed on one of the one or more resources to obtain the exclusion in parallel by optimistic locking control in a first phase, and execute one of the plurality of processes on the resource in a state where the exclusion is obtained by pessimistic locking control in a second phase.

This application is based upon and claims the benefit of priority of the prior Japanese Patent application No. 2018-004323, filed on Jan. 15, 2018, the entire contents of which are incorporated herein by reference.

### FIELD

The embodiment discussed herein relates to an information processing apparatus, a method for controlling, and a non-transitory computer-readable recording medium having stored therein a control program.

### BACKGROUND

In an information system, a competitive operation may sometimes occur in which multiple jobs simultaneously execute processes, such as accesses, on multiple volumes or chunks, which are obtained by dividing each volume in units of a constant logical block size. In order to avoid occurrence of such a competitive operation, exclusion control (mutual exclusion control) is carried out for each resource (hereinafter simply called an object) such as a volume or a chunk.

Accompanying drawings FIGS. 13A and 13B illustrate exclusion control of comparative examples. As illustrated in FIGS. 13A and 13B, the objects have an inclusion relationship in which, for example, one or more chunks 102x, 102y, and 102z are included in a single volume 101. Hereinafter, one of the reference numbers of 102x, 102y, and 102z is used when one of multiple chunks needs to be specified, but an arbitrary chunk is represented by a reference number 102. Besides, the chunk 102x is sometimes referred to as a chunk X; the chunk 102y is sometimes referred to as a chunk Y; and the chunk 102z is sometimes referred to as a chunk Z. Since a volume and a chunk are able to connect to each other, the objects can have two situations of: a situation where a volume 101 accesses a chunk 102; and a situation of the reverse-direction relationship (route), that is, a situation where a chunk 102 accesses a volume 101. FIG. 13A illustrates an example that the chunk X accesses the volume 101. The exclusion control of FIG. 13A needs to first obtain exclusion for the chunk X and then obtain exclusion for the volume 101. In other words, exclusion needs to be obtained in the sequence of the chunk X and the volume 101. The sequence of obtaining exclusion is also referred to as an exclusion sequence. FIG. 13B illustrates an example that the volume 101 accesses the chunk X and the chunk Y. The exclusion control of FIG. 13B needs to obtain exclusion for the volume 101 and after that, obtain exclusion for the chunks X and Y.

[Patent Literature 1] Japanese Laid-open Patent Publication No. 2014-178831

[Patent Literature 2] Japanese Laid-open Patent Publication No. 2009-37544

[Patent Literature 3] Japanese Laid-open Patent Publication No. 2016-95638

In some traditional exclusion controls as the above, the exclusion sequence, which is exemplified by obtaining exclusion firstly for a volume and then for a chunk, is sometimes determined in the design stage. Accompanying drawings FIGS. 14A and 14B illustrate exclusion control in a giant lock scheme of a comparative example. As illustrated in FIG. 14A, in cases where the chunk X is to access the volume A under the above exclusion control, exclusion needs to be obtained in the reverse order to one determined at the design stage, and accordingly, the access process fails to be accomplished. As a solution to this inconvenience, a scheme called giant lock has been known to the art which carries out exclusion control in a wide range, maintaining the exclusion sequence determined at the design stage.

Description will now be made in relation to an example that, in an information processing system adopting a giant lock scheme, the access-source (updating source) chunk X accesses the volumeA (101a) of the access-destination (updating-destination) the volume A (101a) with reference to FIG. 14B. Hereinafter, one of the reference numbers of 101a and 101b is used when one of multiple volumes needs to be specified, but an arbitrary volume is represented by a reference number 101. Besides, the volume 101a is sometimes referred to as a volume A; and the volume 101b is sometimes referred to as a volume B. The giant lock scheme obtains exclusion for all the objects (the chunk X, the chunk Y, and the chunk Z) linked to an access-destination object (i.e., the volume A) irrespective of the presence or absence of an access request. In some cases, exclusion for an object, such as the volume B, which is determined to be relevant to the access-source object under a predetermined condition may be obtained.

In the most cases, it is sufficient for an access from the chunk X to the volume A described above to execute exclusion control only on the range covering the access source and the access destination. Here, a range in which exclusion is to be obtained is referred to as an exclusion range and is represented by a reference number 103 in the drawings. However, in cases where the giant lock scheme is adopted, the exclusion range 103 is set so as to include the volume B, the chunk Y, and the chunk Z as illustrated in FIG. 14B. Accordingly, the exclusion control is carried out beyond the minimum requisite exclusion range, and exclusion control fails to be carried out in the optimum range. As a solution to the above, a scheme is known in which all the objects included in the exclusion range are retrieved in order to minimize the exclusion range, keeping the exclusion sequence determined at the design stage. This scheme retrieves all the volumes linked to the access-source chunk X with reference to, for example, a chunk table, and accordingly obtains one or more objects for which exclusion is to be obtained. Unfortunately, this scheme enormously increases an amount of program code.

### SUMMARY

According to an aspect of the embodiments, an information processing apparatus of an embodiment of the present invention includes a memory; a processor coupled to the memory; and one or more resources, the processor being configured to allow a plurality of the processes to be performed on one of the one or more resources to obtain the exclusion in parallel by optimistic locking control in a first phase, and execute one of the plurality of processes on the resource in a state where the exclusion is obtained by pessimistic locking control in a second phase.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the hardware configuration of an information processing system according to an example of an embodiment;

FIGS. 2A and 2B are diagrams illustrating an operation to make a storage device persistent in an information processing system according to an example of the embodiment;

FIGS. 3A and 3B are diagrams illustrating an example of displaying the hardware configuration of an information processing system according to an example of the embodiment;

FIG. 4 is a diagram illustrating an example of the functional block of a server of an information processing system according to an example of the embodiment;

FIGS. 5A and 5B are diagrams illustrating an example of displaying a volume table and a chunk table of an information processing system according to an example of the embodiment, the tables being displayed in object-oriented modeling;

FIG. 6 is a diagram illustrating an example of exclusion control in an information processing system according to an example of the embodiment;

FIG. 7 is a flow diagram illustrating an exclusion obtaining phase of an information processing system according to an example of the embodiment;

FIG. 8 is a diagram illustrating an example of the exclusion obtaining phase of an information processing system according to an example of the embodiment;

FIG. 9 is a diagram illustrating an example of an exclusion control table of an information processing system according to an example of the embodiment;

FIG. 10 a flow diagram illustrating a process executing phase of an information processing system according to an example of the embodiment;

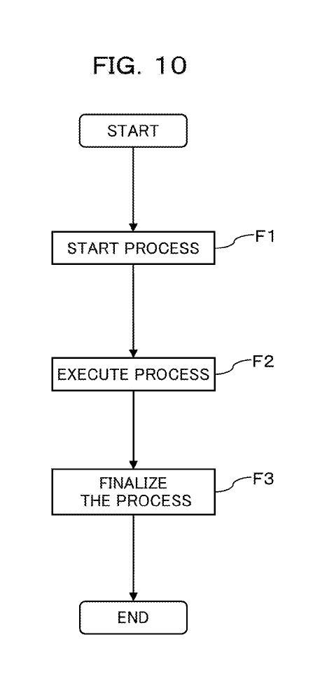

FIG. 11 is a diagram illustrating an example of the process executing phase of an information processing system according to an example of the embodiment;

FIG. 12 is a diagram illustrating an example of overtaking in an information processing system according to an example of the embodiment;

FIGS. 13A and 13B are diagrams illustrating examples of exclusion control according to comparative examples of the embodiment; and

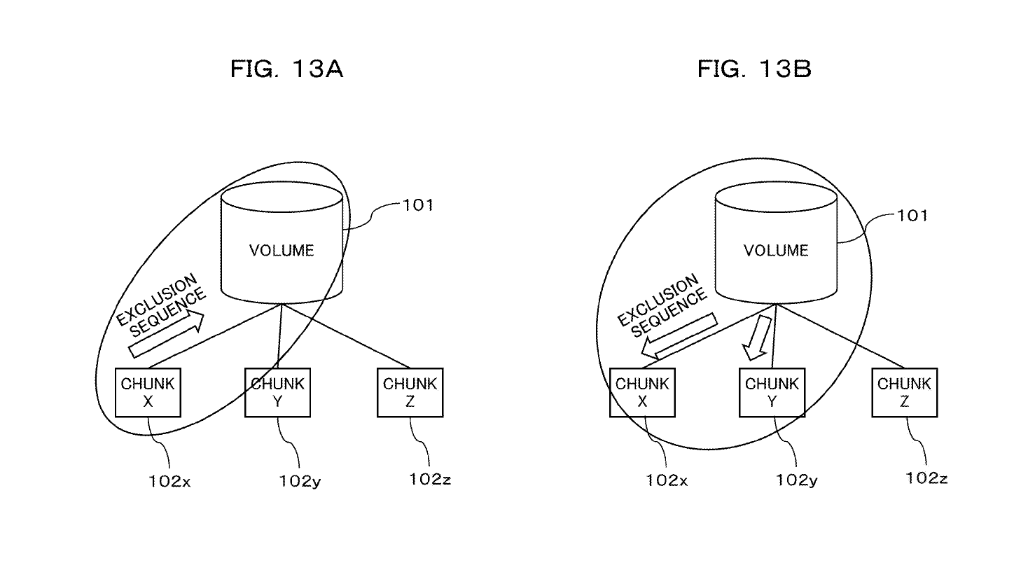

FIGS. 14A and 14B are diagrams illustrating an example of exclusion control in a giant lock scheme according to another comparative example of the embodiment.

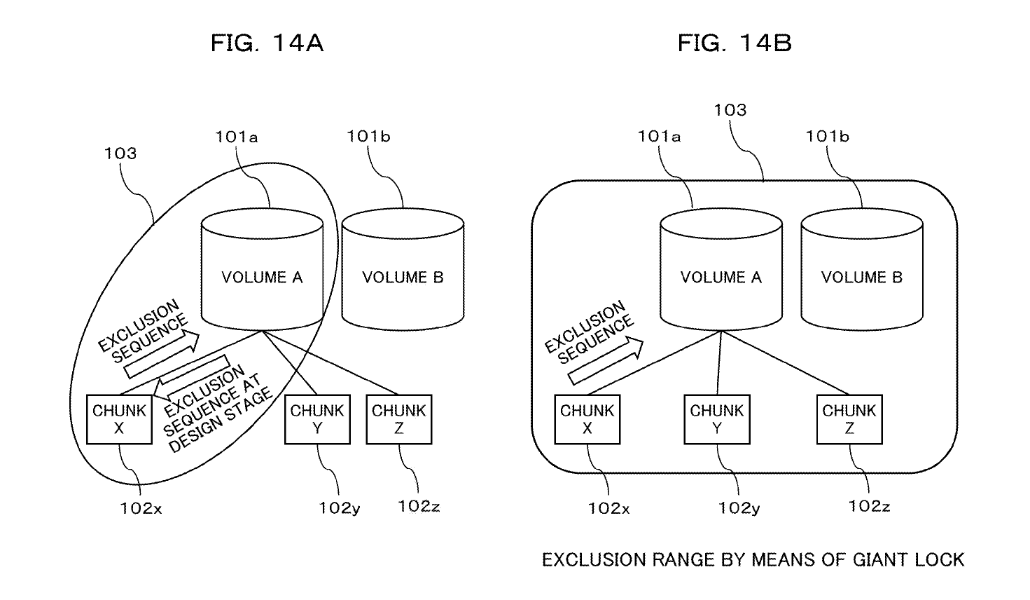

### DESCRIPTION OF EMBODIMENTS

Hereinafter, description will now be made in relation to an embodiment of the present invention with reference to the accompanying diagram. The embodiment to be detailed below is merely exemplary and does not have intention to exclude various modifications and applications of techniques not referred in the following embodiment. For example, the following embodiment may be variously modified without departing from the scope thereof. Throughout the drawings used in the following embodiment, like reference numbers designate the same or substantially same part and elements unless otherwise described.

(1) One Embodiment

(1-1) Example of the Configuration of the Information Processing System of the Embodiment:

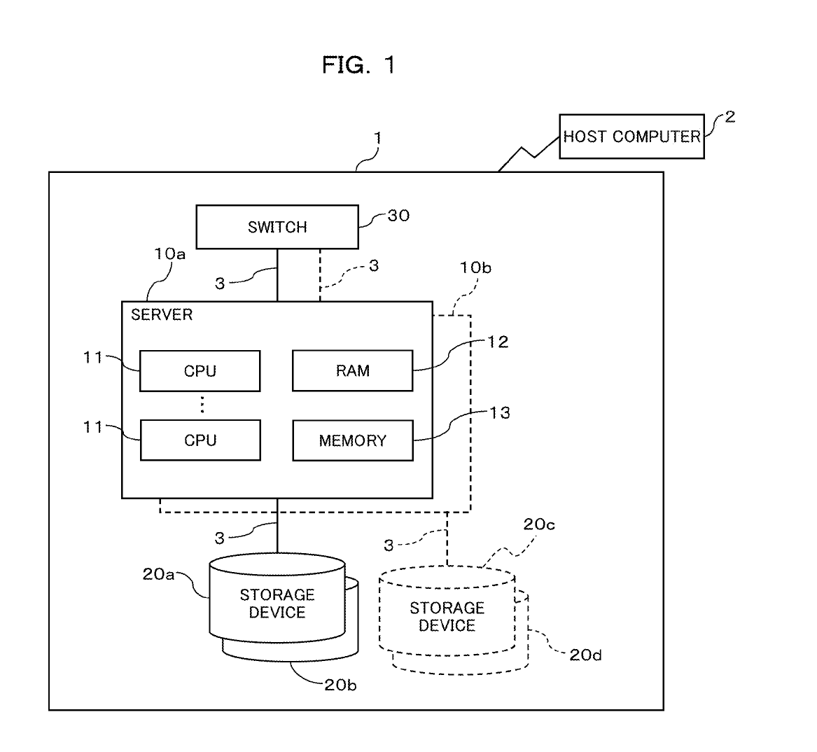

FIG. 1 is a diagram illustrating an example of the hardware configuration of an information processing system 1 according to an example of the present embodiment.

As illustrated in FIG. 1, the information processing system 1 includes a server 10a, a server 10b, and a switch 30. The servers 10a and 10b are connected to the switch 30 via a network 3. Hereinafter, one of the reference numbers of 10a and 10b is used when one of multiple server needs to be specified, but an arbitrary server is represented by a reference number 10. Besides, the server 10a is sometimes referred to as a server A; and the server 10b is sometimes referred to as a server B. Furthermore, the information processing system 1 includes storage devices 20a-20d, which are connected to the servers 10 via the network 3. Hereinafter, one of the reference numbers of 20a, 20b, 20c, and 20d is used when one of multiple storage devices needs to be specified, but an arbitrary storage device is represented by a reference number 20. Besides, the storage device 20a is sometimes referred to as a storage device A; the storage device 20b is sometimes referred to as a storage device B; the storage device 20c is sometimes referred to as a storage device C; and the storage device 20d is sometimes referred to as a storage device D. The information processing system 1 is connected to a host computer 2, which is an external device for example, via a non-illustrated network. FIG. 1 illustrates the information processing system 1, which includes a single switch 30, but alternatively, the information processing system 1 may include multiple switches 30. FIG. 1 illustrates the information processing system 1, which includes multiple servers 10 and the storage devices 20, but alternatively the information processing system 1 may a single server 10 and a single storage device 20.

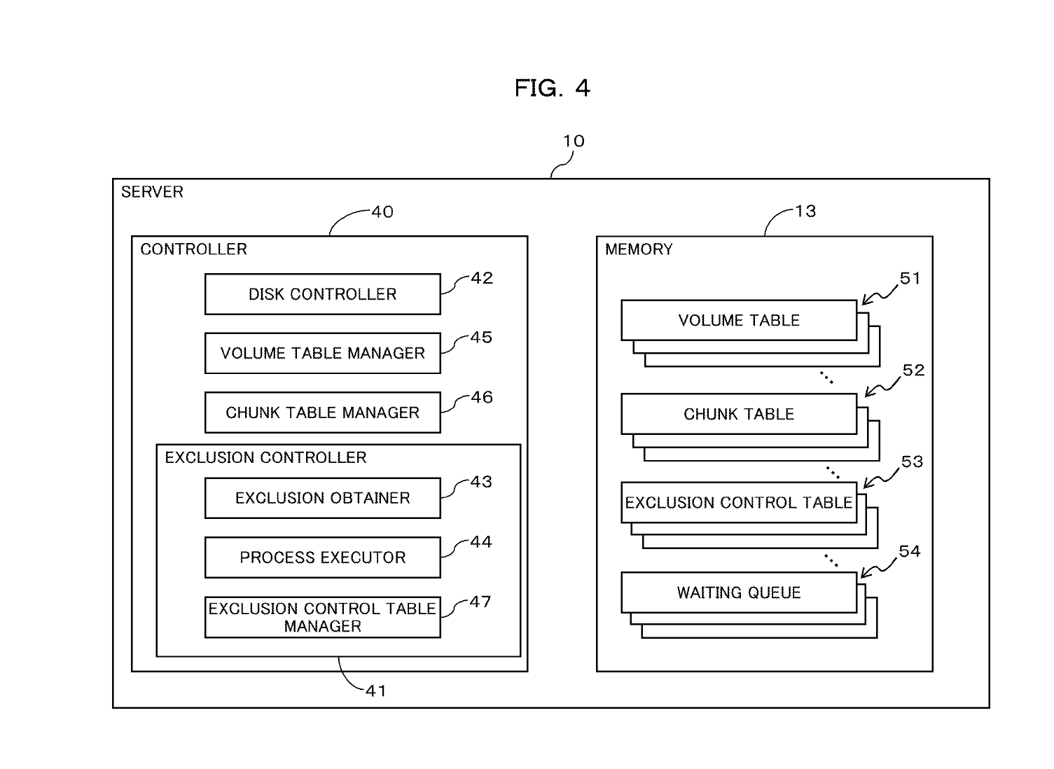

Each server 10 includes multiple Central Processing Units (CPUs) 11 each having a multi-core configuration. The server 10 further includes a Random-Access Memory (RAM) 12, and a memory 13. Each CPU 11 executes the Operating System (OS) and programs stored in the memory 13, and carries out exclusion control of an object in response to an access request input from an external device exemplified by the host computer 2. The memory 13 is a non-volatile memory, for example, and stores a volume table 51, a chunk table 52, a waiting queues 54, and an exclusion control table 53 (see FIG. 4) in addition to one or more programs that carry out communication control with the host computer 2 and exclusion control.

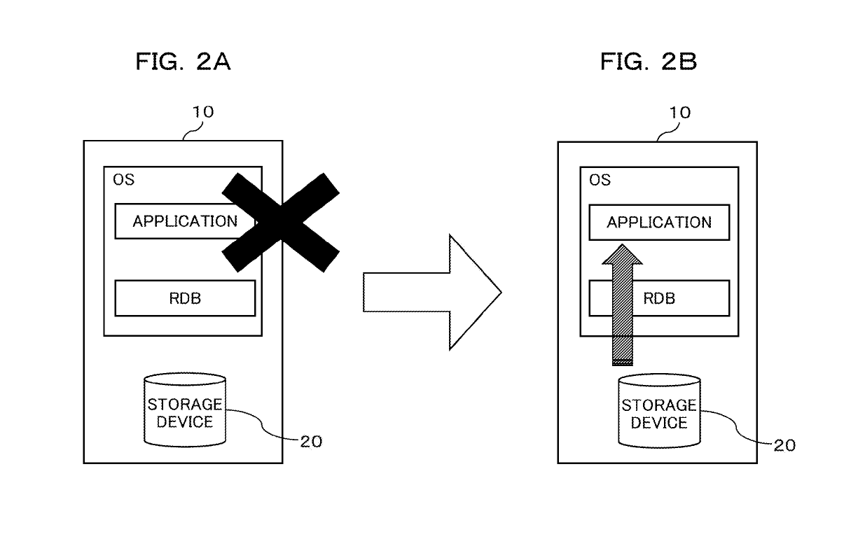

Each storage device (database for management) 20 is a physical disk used for a Relational Database (RDB), and multiple objects are mapped on the RDB. An example of each storage device 20 is a database (persistent database) aiming at making the information to be stored therein persistent. The information to be stored therein is information to achieve the persistence, which information can be regarded as information to be persistent. FIGS. 2A and 2B are diagrams illustrating an operation to make the information in the storage device 20 persistent in the present embodiment. As illustrated in FIG. 2A, a case where an application is restarted as a result of, for example, process down of the OS of the server 10 is assumed. In this case, the present information processing system 1 restores jobs and objects of the server 10 by using information to be persistent as illustrated in FIG. 2B. Consequently, the server 10 can resume the execution of the application of the server 10, using the objects and the jobs stored in the storage device 20 immediately before the restart.

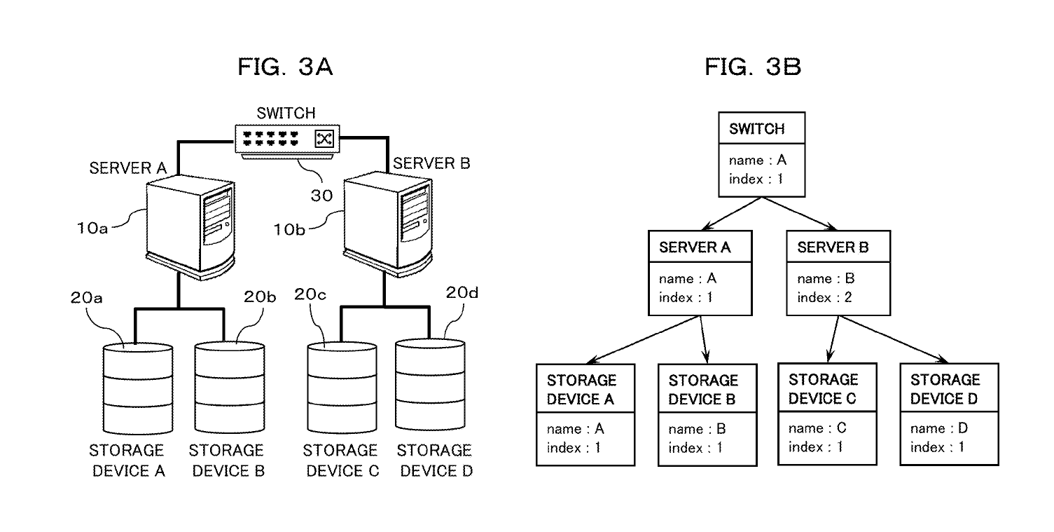

Next, FIGS. 3A and 3B illustrate an example of displaying the hardware configuration of the present information processing system 1. FIG. 3A illustrates an example of the hardware configuration of the present information processing system 1. As illustrated in FIG. 3A, the switch 30 is connected to the server A and the server B. To the server A, the storage device A and the storage device B are connected, and to the server B, the storage device C and the storage device D are connected. FIG. 3B illustrates an example of the hardware configuration of FIG. 3A expressed by means of object-oriented modeling. As illustrated in FIG. 3B, using object-oriented modeling makes it possible to explicitly illustrate an attribute of each object, such as the switch 30, the server 10, and the storage device 20. For example, it is explicitly illustrated that the switch 30 has a value (attribute value) “A” of an attribute “name” and the value “1” of an attribute “index”. The arrows in FIG. 3B represent referring relationships between objects. A referring relationship is achieved by, for example, a referring table that each object stores. The referring table defines a referring relationship from the switch 30 to the server A and a referring relationship from the server A to the storage device B. Alternatively, the referring table may define opposite referring routes to the above, that is, a referring relationship from the storage device B to the server A and a referring relationship from the server A to the switch 30. An object may store multiple referring tables. Such a referring table is known to the art, so description thereof is omitted here.

(1-2) Example of Functional Configuration of the Server in the Information Processing System According to the Embodiment:

FIG. 4 is a block diagram schematically illustrating an example of the functional configuration of the server 10 of the information processing system 1 illustrated in FIG. 1.

As illustrated in FIG. 4, the server 10 of the information processing system 1 according to an embodiment may exemplarily include a controller 40 and the memory 13. The controller 40 may include a disk controller 42, a volume table manager 45, a chunk table manager 46, and an exclusion controller 41. The exclusion controller 41 may include an exclusion obtainer 43, a process executor 44, and an exclusion control table manager 47.

The exclusion controller 41 carries out, in cases where the host computer 2 is connected to the present information processing system 1 and the host computer 2 issues an access request, exclusion control responsively on an object related to the access request.

The disk controller 42 controls, in cases where the host computer 2 is connected to the present information processing system 1, an access process of, for example, writing data into and reading data from a storage device 20. This means that the disk controller 42 writes data in the memory 13 into a storage device 20 and stores data in a storage device 20 into the memory 13.

The exclusion obtainer 43 carries out, as a part of the exclusion control carried out by the exclusion controller 41, an exclusion obtaining phase (prepare) that is to be detailed below. The exclusion obtaining phase is also referred to as a first phase.

The process executor 44 carries out, as another part of the exclusion control carried out by the exclusion controller 41, a process executing phase (execute) that is to be detailed below. The process executing phase is also referred to as a second phase.

The volume table manager 45 manages a volume table 51 that is to be detailed below. In other words, the volume table manager 45 manages, for example, attribute values related to each volume included in the present information processing system 1, using the volume table 51.

The chunk table manager 46 manages the chunk table 52 that is to be detailed below. In other words, the chunk table manager 46 manages allocation of a physical region to a chunk included in a volume, using the chunk table 52.

The exclusion control table manager 47 obtains (refers to) an exclusion control table 53 of an object, which table is to be detailed below, and updates the values stored in the exclusion control table 53. In cases where each object stores its own exclusion control table 53, the exclusion control table manager 47 obtains or updates the exclusion control table 53 of the object via the network 3.

The memory 13 of the server 10 stores the volume table 51, the chunk table 52, the exclusion control table 53, and the waiting queue 54. Alternatively, the memory 13 may store multiple volume tables 51, multiple chunk tables 52, multiple exclusion control tables 53, and multiple waiting queues 54.

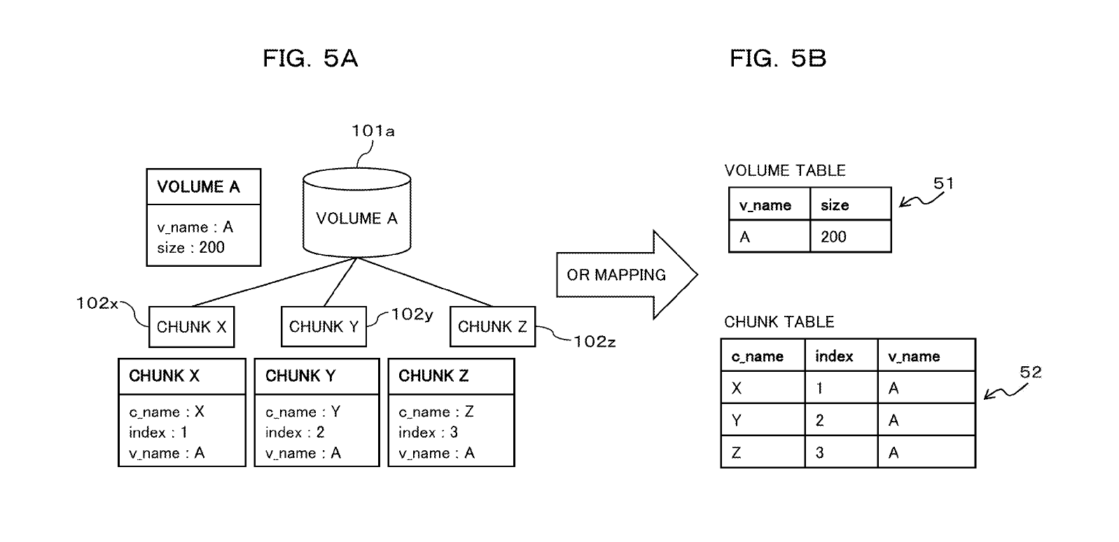

FIGS. 5A and 5B are diagrams illustrating a volume table 51 and a chunk table 52 in the information processing system 1 according to an example of the present embodiment. FIG. 5A illustrates the objects of the volume A and the chunks 102 by means of object-oriented modeling; and FIG. 5B expresses the object-oriented model of FIG. 5A in a relational data model using Object/Relational (OR) mapping.

The volume table 51 includes a field “v_name” to store the volume name of each volume 101 and a field “size” to store the size of the volume 101. FIG. 5B illustrates an example of the volume table 51 of the volume A, and the illustrated volume table 51 indicates that a volume having a volume name “A” has a size “200”. Here, an arbitrary unit is used for the size of the volume 101.

The chunk table 52 includes a field “c_name” to store the chunk name of each chunk 102, and a field “index” to store the index of the chunk 102. The chunk table 52 further includes a field “v_name” to store the associated volume name. The index of a chunk 102 is an identification number provided to the chunk 102, and the associated volume name represents a volume having a physical region to be allocated to the chunk 102. FIG. 5B illustrates an example chunk table 52 which stores information about the chunk X, the chunk Y, and the chunk Z. For example, the first record of the chunk table 52 indicates that the chunk 102 having a chunk name “X” has an index “1” and a volume “A” having a physical region to be allocated to the chunk 102.

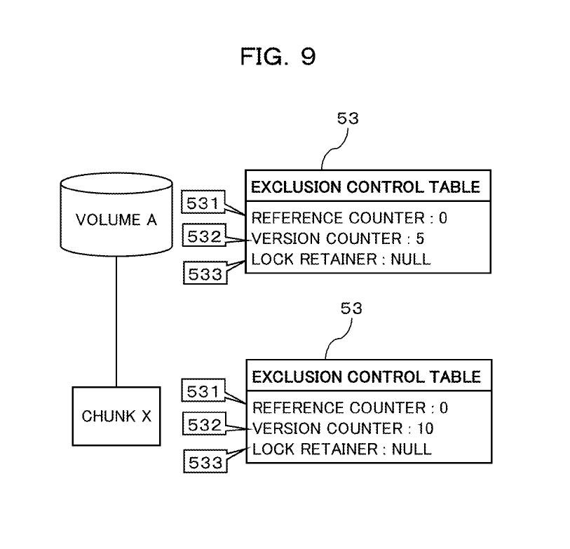

An exclusion control table 53 represents information to manage a state (competitive state) of occurrence of competition (conflict) of jobs and is provided for each object. The exclusion control table 53 will be further detailed below with reference to FIG. 9. In the present embodiment, the exclusion control table 53 takes a table form, but the form of the exclusion control table 53 is not limited to this.

The waiting queue 54 is a queue that stores a competitive job that fails to obtain exclusion.

(1-3) Exclusion Control Process in the Information Processing System of the Present Embodiment:

Description will now be made in relation to a process of exclusion control in the information processing system 1 of an example of the present embodiment.

In the present embodiment, the exclusion control of the information processing system 1 is divided into two phases of an exclusion obtaining phase and a process executing phase.

First of all, the exclusion obtaining phase of the present embodiment will now be described. The exclusion obtaining phase corresponds to a preparation stage to obtain exclusion and execute optimistic locking control. Consequently, multiple jobs are allowed to access an object in parallel with one another to obtain exclusion of the access-destination object. Such optimistic locking control has been known to the public, so the detailed description is omitted here. The exclusion obtaining phase is achieved by the exclusion obtainer 43.

Next, the process executing phase of the present embodiment will now be described. The process executing phase corresponds to a stage of executing a process after exclusion is obtained in the exclusion obtaining phase, and specifically carries out pessimistic locking control. Accordingly, only a job that obtains exclusion is allowed to access the target object and, in cases where one or more jobs (competitive jobs) that failed to obtain exclusion are present, the jobs are added to the waiting queue 54. Such pessimistic locking control has been known to the public, so the detailed description is omitted here. The process executing phase is achieved by the process executor 44.

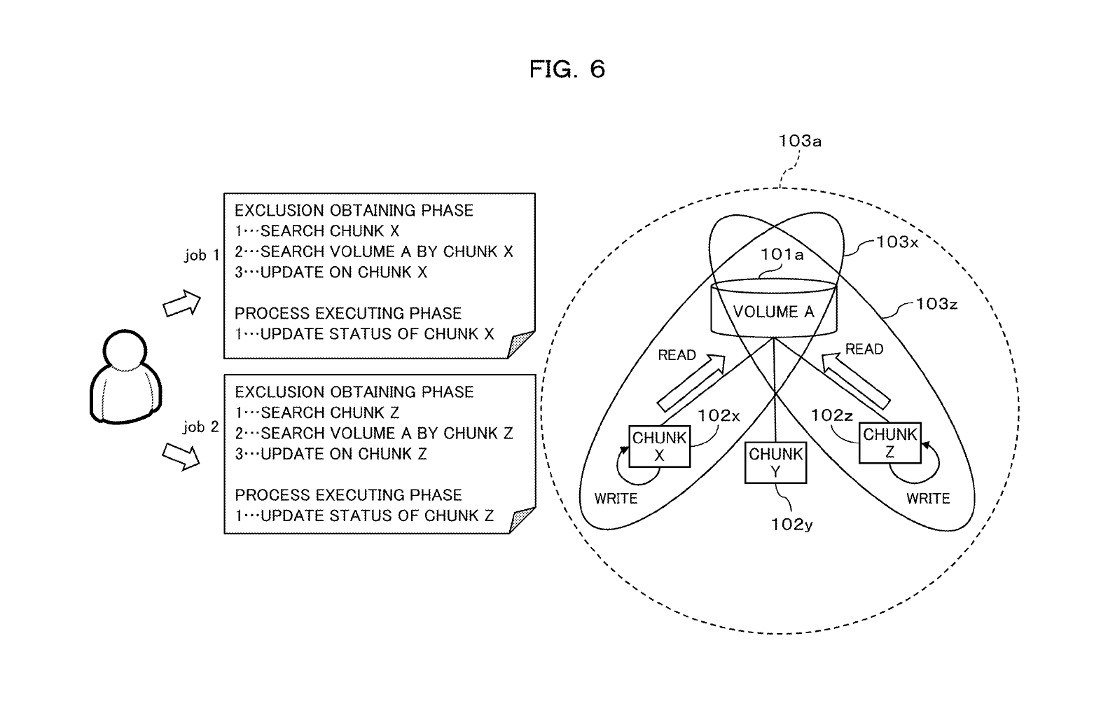

FIG. 6 illustrates an example of the exclusion control of the present embodiment. FIG. 6 assumes that two jobs (job1, job2) are input by the manager via the host computer 2. Here, the job 1 includes a process of reading the volume A by the chunk X and the job 2 includes a process of reading the volume A by the chunk Z. By referring to instructions (commands) of the respective jobs of FIG. 6, being clearly indicated by the second command of the exclusion obtaining phase with reference the job 1 and the job 2 both include a process of searching the volume A. Then, as clearly indicated by the first command of the process executing phase of the job 1 and the job 2, the job 1 and the job 2 both write data into the respective chunks. Namely, since neither the job 1 nor the job 2 writes data into the volume A, the job 1 and the job 2 have a high possibility of being simultaneously executable.

When the job 1 and the job 2 as denoted in FIG. 6 are input, exclusion control adopting the giant lock scheme sets an exclusion range 103a that allows either one of the jobs to access the volume A. Consequently, the job 1 and the job 2 are not allowed to be simultaneously carried out and either one of the jobs is executed. The exclusion control of the present embodiment limits the exclusion range to the exclusion range 103x covering the chunk X and the volume A and the exclusion range 103z covering the chunk Z and the volume A, so that the job 1 and the job 2 can be executed in parallel with each other. Accordingly, this can enhance the throughput of processing by the entirety of the information processing system 1 and allows jobs to access the respective target objects irrespective of the exclusion sequence.

(1-4) Example of Operation:

Next, description will now be made in relation to examples of operations of the exclusion obtaining phase and the process executing phase carried out by the information processing system 1 having the above configuration.

(1-4-1) Example of the Operation in the Exclusion Obtaining Phase of the Information Processing System of the Present Embodiment:

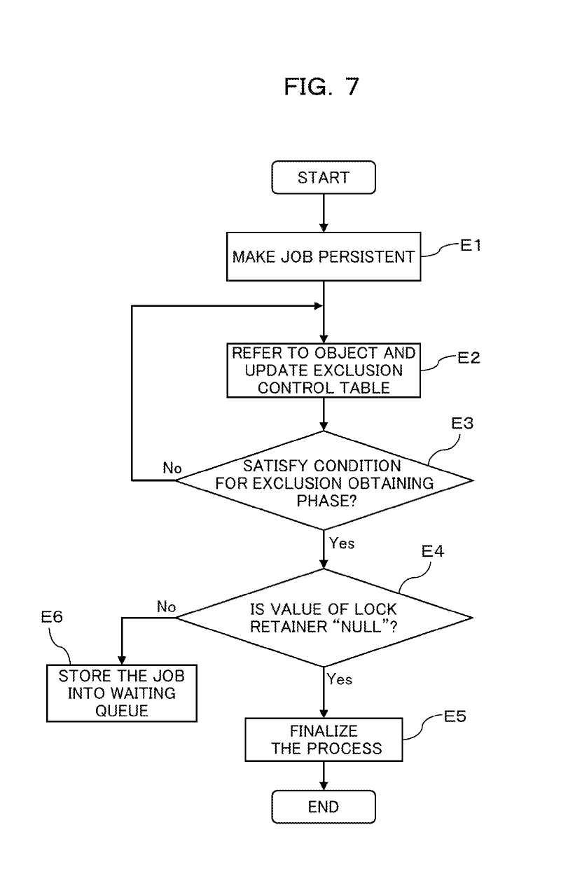

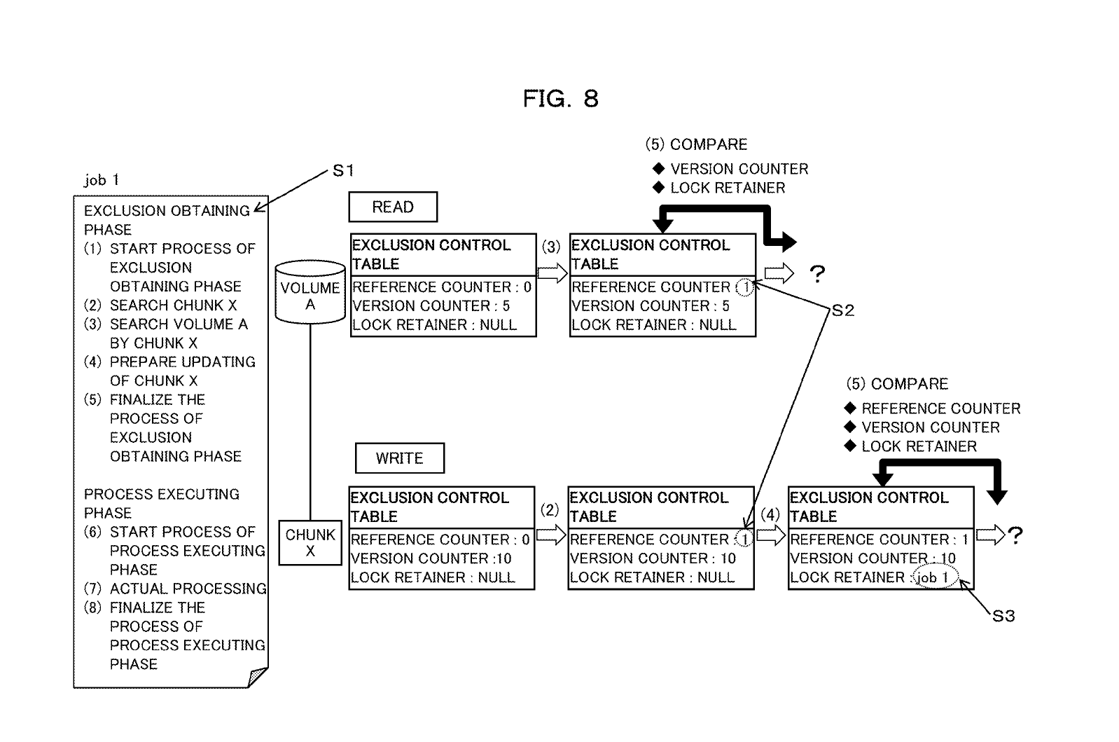

Description will now be made in relation to an example of the operation in the exclusion obtaining phase of the present embodiment along the flow diagram of FIG. 7 (Steps E1-E6) by referring to FIGS. 8 and 9. FIG. 8 is a diagram illustrating an example of the exclusion obtaining phase of the present embodiment, and particularly illustrating a process when a job (the job 1) is input by the manager via the host computer 2. FIG. 9 is a diagram illustrating an example of the exclusion control table 53 according to the present embodiment.

When the manager inputs a job from the host computer 2, the exclusion controller 41 receives the input job and requests, for example, the disk controller 42 to store the received job into the storage device 20 in Step E1. When being stored in the storage device 20, the input job becomes information that makes the information stored in the storage device 20 to be persistent. Then, the exclusion controller 41 instructs the exclusion obtainer 43 to carryout the exclusion obtaining phase for the job received in Step E1. In the example illustrated in FIG. 8, the exclusion controller 41 receives the job 1 and then instructs the exclusion obtainer 43 to carry out the exclusion obtaining phase for the job 1 (see reference number S1).

In Step E2, the job refers to an object, and the exclusion obtainer requests the exclusion control table manager 47 to update the exclusion control table 53 of the object.

Here, description will now be made in relation to the exclusion control table 53 of the present embodiment with reference to FIG. 9.

The exclusion control table (exclusion control information) 53 is control information to be used to execute exclusion and is provided for each object. The exclusion control table 53 is stored in, for example, the storage device 20. The exclusion control table 53 has components of a reference counter 531, a version counter 532, and a lock retainer 533.

The reference counter (reference status) 531 is indicative of the real-time number of jobs referring to the object. When a job starts to referring to the object, the value “1” is added to the reference counter 531, and after the process executing phase to be detailed below is completed, the value “1” is subtracted from the number represented by the counter. FIG. 9 illustrates an examples of the exclusion control table 53 of the volume A and the exclusion control table 53 of the chunk X. In the example of FIG. 9, the values of the reference counters 531 of the volume A and the chunk X are both “0”, which represents that no job is referring to the volume A and the chunk X.

The version counter (version status) 532 is indicative of the status of updating (version of) data in the object. In cases where the data is written (updated), the value “1” is added to the version counter 532 after the process executing phase to be detailed below is completed. In the example of FIG. 9, the exclusion control table 53 of the chunk X sets the value of the version counter 532 to “10”, which indicates that the version of the data in the chunk X is “10”; and the exclusion control table 53 of the volume A sets the value of the version counter 532 to “5”, which indicates that the version of the data in the volume A is “5”.

The lock retainer (i.e., a job that has obtained exclusion) 533 indicates a job that has obtained exclusion. For example, the identifier (ID) of the job is set in the lock retainer 533. In the present embodiment, the value of the lock retainer 533 is written in Step E2 of FIG. 7 and is deleted when the process executing phase that is to be detailed below is completed. In cases where the lock retainer 533 is not set, the value “NULL” is set in the lock retainer 533 as illustrated in FIG. 9.

In the present embodiment, the exclusion control table 53, which is provided for each object, is referred or updated when a process is carried out on the object and therefore can be said to be indicative of the latest status. The latest exclusion control table 53 that is updated after the execution of a process on the object may be stored in the memory 13 of the server 10.

The present embodiment carries out the process related to the exclusion control using the exclusion control table 53, which stores the above values.

Now, description will now be returned in relation to Step E2 of the flow diagram of FIG. 7. When the job refers to the object in Step E2, the exclusion obtainer 43 requests the exclusion control table manager 47 to update the exclusion control table 53 of the object referred to by the job. In response to the request from the exclusion obtainer 43, the exclusion control table manager 47 obtains the exclusion control table 53 of the object that is to be updated. For the job 1 exemplarily illustrated in FIG. 8, the chunk X is searched in the process (2) and the volume A is searched in the process (3). Since the chunk X and the volume A are thereby referred to, the exclusion control table manager 47 obtains the exclusion control tables 53 of the chunk X and the volume A. In cases where these exclusion control tables 53 are stored in the respective objects, the exclusion control table manager 47 obtains the exclusion control tables 53 from, for example, the storage devices 20 through the network 3. Furthermore, the exclusion control table manager 47 may temporarily store these obtained exclusion control tables 53 in the memory 13, or may update the latest exclusion control tables 53 stored in the memory 13 at the time point of obtaining these exclusion control tables 53. As a result of the chunk X and the volume A being referred to by the job 1, the exclusion control table manager 47 adds the value “1” to the values of the reference counters 531 of the exclusion control tables 53 of the chunk X and the volume A (see S2). Next, since the job 1 exemplarily illustrated in FIG. 8 includes preparation for updating the chunk X in the process (4), the exclusion control table manager 47 sets the value “job 1” in the value of the lock retainer 533 of the exclusion control table 53 of the chunk X (see S3).

In the ensuing step E3, the exclusion obtainer 43 confirms whether or not the values of the reference counter 531 and the version counter 532 of the exclusion control table 53 of the object referred by the job are updated. For example, in cases where the job carries out a reading process, the exclusion obtainer 43 confirms whether or not the value of the version counter 532 in the exclusion control table 53 of the target object is changed. The purpose in confirming whether or not the value of the version counter 532 is changed is to confirm that the data is not updated by another job immediately before the job reads data. For example, in cases where the job carries out a writing process, the exclusion obtainer 43 confirms whether the values of the reference counter 531 and the version counter 532 in the exclusion control table 53 of the target object are changed. The purpose in confirming whether the values of the reference counter 531 and the version counter 532 are changed is to confirm that data is not referred to or updated by another job immediately before the job writes data. In the example of FIG. 8, the exclusion obtainer 43 confirms, in the process (5), whether or not the value of the version counter 532 of the exclusion control table 53 of the volume A of the reading target is changed. At the same time, the exclusion obtainer 43 confirms whether or not the values of the reference counter 531 and the version counter 532 of the exclusion control table 53 of the chunk X of the writing target are changed. In cases where all the confirmed values are not changed, the exclusion obtainer 43 determines that the condition for the exclusion obtaining phase is satisfied and moves the process to Step E4 (Yes in Step E3). In contrast, in cases where any of the above confirmed values is changed, the exclusion obtainer 43 determines that the condition for the exclusion obtaining phase is not satisfied and returns the process to Step E2 (No in Step E3).

In step E4, the exclusion obtainer 43 determines whether or not the value “NULL” is set in the lock retainer 533 in the exclusion control table 53 of an object being referred to by the job. In cases where the exclusion obtainer 43 determines that the value “NULL” is set in the lock retainer 53, the process proceeds to Step E5 (Yes in Step E4). On the other hand, in cases where the exclusion obtainer 43 determines that a value different from “NULL” is set in the lock retainer 533 (No in Step E4), there is a high possibility that another job obtains exclusion for the object being referred to. Consequently, the job, which is determined to have failed to obtain the exclusion, is stored into a waiting queue 54 (Step E6). Although not illustrated here, the process of the exclusion obtaining phase for a job stored in the waiting queue 54 may be resumed (executed again) at a predetermined timing. As an example of this case, the process of the job may be restarted from Step E1 of FIG. 7.

Instep E5, a process of obtaining exclusion is carried out as a finalization process. In the example of FIG. 8, the least necessary objects for which the exclusion is obtained are the chunk X and the volume A, so that the exclusion obtainer 43 obtains the exclusion for the job 1 over the chunk X and the volume A concurrently with each other. The specific manner of obtaining exclusion may be any manner known to the public. When the process of Step E5 finishes, the exclusion obtaining phase also finishes.

In cases where the job successfully obtains exclusion through the steps (i.e., Steps E1-E6) of the above exclusion obtaining phase, the process is shifted to the ensuing process executing phase (i.e., transition from the first phase to the second phase).

(1-4-2) Example of the Operation in the Process Executing Phase of the Information Processing System of the Present Embodiment:

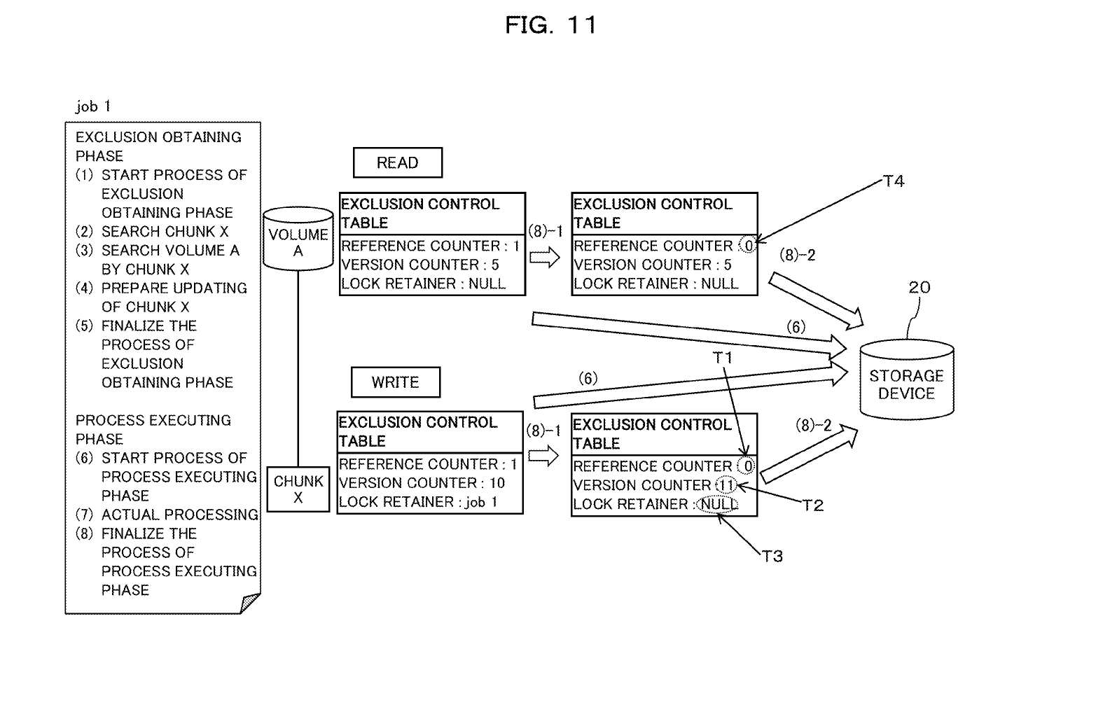

Description will now be made in relation to an example of the operation in the process executing phase performed in the information processing system 1 according to an example of the present embodiment along the flow diagram (Steps F1-F3) by referring to FIG. 11. FIG. 11 is a diagram illustrating the process executing phase of the present embodiment.

The process executor 44 receives notification that the exclusion obtaining phase is finished (notification that exclusion obtaining is completed) from the exclusion obtainer 43 and moves into the process executing phase (Step F1-F3). In Step F1, the process executor 44 requests the disk controller 42 to store the exclusion control table 53 referred to by the job into, for example, the storage device 20. The data in the object of the stored exclusion control table 53 is made persistent by the disk controller 42 storing the exclusion control table 53 in the storage device 20. In the example of FIG. 11, the disk controller 42 stores the exclusion control tables 53 of the chunk X and the volume A into the storage device 20 as the process (6).

In the next step F2, the process executor 44 carries out the actual process and thereby the object is updated. The specific contents of the actual process that the process executor 44 carries out is a process unique to the job. In the example of FIG. 11, the process executor 44 carries out data reading from the volume A and data writing into the chunk X. Consequently, the chunk X (the data in the chunk X) is updated.

In the ensuing step F3, the process executor 44 performs the finalization process of the process executing phase. Specifically, the process executor 44 requests the disk controller 42 to store (the information of) the object referred to by the job into, for example, the storage device 20. Furthermore, the process executor 44 carries out a process of cancelling the exclusion obtained for the job and requests the exclusion control table manager 47 to update the information of the exclusion control table 53. In the example of FIG. 11, since referring to the chunk X is finished in the process (8) of the job 1, the exclusion control table manager 47 subtracts the value “1” from the value of the reference counter 531 of the exclusion control table 53 of the chunk X (see T1). At the same time, since the data is rewritten into the chunk X, the exclusion control table manager 47 adds the value “1” to the value of the version counter 532 of the exclusion control table 53 of the chunk X (see T2). Further concurrently, since the exclusion obtained for the job 1 is cancelled, the exclusion control table manager 47 sets the value “NULL” in the lock retainer 533 of the exclusion control table 53 of the chunk X (see T3 of the process (8)-1). In addition, since the referring to the volume A is also finished, the exclusion control table manager 47 subtracts the value “1” from the value of the reference counter 531 of the exclusion control table 53 of the volume A (see T4 of the process (8)-1).

In step F3, the process executor 44 requests the disk controller 42 to store the updated exclusion control table 53 into, for example, the storage device 20. Consequently, the object is made persistent by the disk controller 42 storing (the information of) the referred object and/or the updated exclusion control table 53 into, for example, the storage device 20. In the example 11, as carried out in the process (8)-2, the disk controller 42 stores the information of the volume A and the chunk X and the exclusion control tables 53 of the volume A and the chunk X into the storage device 20.

In the manner described above, in cases where multiple competitive jobs are present, it is sufficient that the present embodiment carries out a process of obtaining exclusion immediately before any one of the jobs starts its process and releases the obtained exclusion immediately after the process is completed. This eliminates the requirement for executing the process of obtaining exclusion throughout the time period from requesting a process to completing the process. Consequently, since the time period for which a process of obtaining exclusion can be shortened in the present embodiment, the time period for which another job can access the object is prolonged, resulting in enhancement in process throughput.

(1-5) Process when Overtaking Occurs in the Information Processing System of the Present Embodiment:

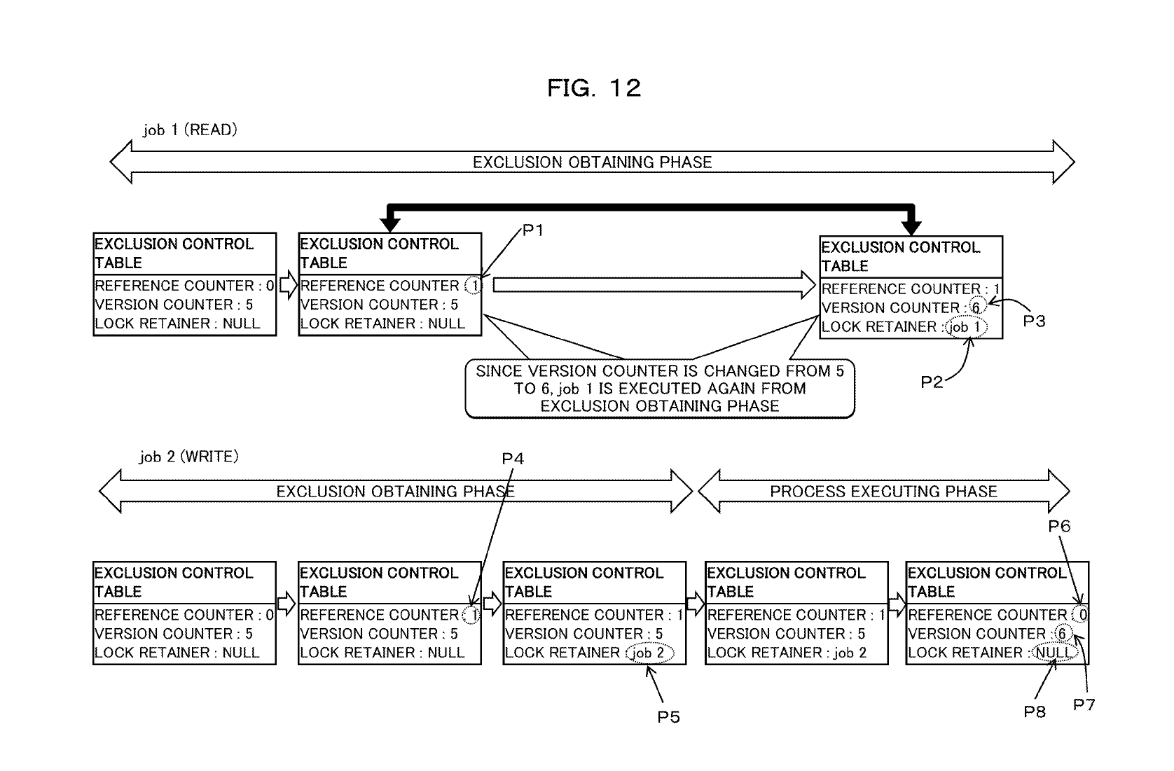

Description will now be made in relation to a process performed when overtaking occurs in the information processing system 1 according to an example of the present embodiment with reference to FIG. 12.

FIG. 12 is an example in which an antecedent job 1 is input; a descendent job 2 overtakes the job 1 while the exclusion obtaining phase for the job 1 is being carried out and updates the object referred to; and consequently the job 1 is carried out again. The job 1 carries out a reading process on a predetermined object. As illustrated in FIG. 12, the job 1 reads data having of the version “5”. If such a job 1 is input, the process related to the job 1 is moved into the exclusion obtaining phase in which the exclusion control table 53 to be referred to by the job 1 is obtained and then the value “1” is added to the value of the reference counter 531 of the exclusion control table 53 of the object referred to by the job 1 (see P1). The value “job 1” is set in the lock retainer 533 of the exclusion control table 53 of the referred object (see P2). Also in relation to the job 2, the value “1” is added to the value of the reference counter 531 (see P4) and the value “job 2” is set in the lock retainer 533 (see P5) in the exclusion control table 53 of the object referred to by the job 2.

As illustrated in FIG. 12, it is assumed that the job 2 is input as the descendent job. The job 2 carries out a writing process on the same object as the job 1. Here, it is assumed that, during the exclusion obtaining phases of the job 1 and the job 2, the exclusion for the job 2 is obtained earlier than the exclusion for the job 1, which means that the job 2 comes into the process executing phase earlier than the job 1. As illustrated in FIG. 12, as a result of executing the writing process of the job 2 earlier than the job 1, a state where the version of the object is updated from “5” to “6”, which means overtaking by another job occurs. Consequently, the exclusion obtainer 43 determines the value of the version counter 532 of the exclusion control table 53 of the referred object to have changed in the exclusion obtaining phase for the job 1 (see P3), and executes the process of the job 1 again. After the process executing phase of the job 2 is completed, the value “1” is subtracted from the value of the reference counter 531 (see P6) and the value “1” is added to the value of the version counter 532 (see P7) in the exclusion control table 53 of the referred object. At the same time, the value “NULL” is set in the lock retainer 533 of the exclusion control table 53 of the object referred by the job 2 (see P8).

As described above, providing the version counter 532 to the exclusion control table 53 as well as the reference counter 531 makes it possible to, in cases where overtaking as illustrated in FIG. 12 occurs, suspend and resume the overtaken process.

(2) Effects:

As detailed above, the information processing system 1 of the present embodiment divides the exclusion control into the exclusion obtaining phase and the process executing phase, and carries out optimistic locking control in the exclusion obtaining phase, so that the exclusion is not obtained until immediately before the execution of the process. This shortens the time period for which the exclusion is obtained over a particular object, and thereby prolongs the time (period) for which another job can access the particular object. Furthermore, the information processing system 1 of the present embodiment can carry out the exclusion control in the optimum range by restricting the exclusion range. Thereby, the throughput of the process of the entire information processing system 1 can be enhanced.

The information processing system 1 of the present invention saves the amount of program code to be implemented, and can thereby achieve versatile implementation.

The information processing system 1 of the present embodiment carries out the exclusion control, using the exclusion control tables 53, and can thereby efficiently carry out the exclusion control even under a state of the presence of multiple competitive jobs.

Even when overtaking as illustrated in FIG. 12 occurs, the information processing system 1 of the present embodiment can suspend and resume a job that fails to obtain exclusion. Accordingly, in cases where the version of data to be read is different from the desired version, it is possible to avoid the circumstance where data of the different version is read.

(3) Others:

The technique according to the embodiment detailed above can be changed or modified as follows.

In the information processing system 1 of the above embodiment, the exclusion control table 53 for each object is stored in the storage device 20, but may alternatively be stored in, for example, the memory 13 of the server 10.

In the information processing system 1 of the above embodiment, the exclusion control tables 53 are provided one for each object, but alternatively a competitive state for multiple objects may be managed with a single table.

According to the embodiment described above, exclusion control can be accomplished in the optimum range in an information processing system.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory;
a processor coupled to the memory; and
one or more resources,
the processor being configured to
allow a plurality of the processes to be performed on one of the one or more resources to obtain the exclusion in parallel by optimistic locking control in a first phase, and
execute one of the plurality of processes on the resource in a state where the exclusion is obtained by pessimistic locking control in a second phase.

2. The information processing apparatus according to claim 1, wherein in a case where one or more competitive processes with the process executed in the second phase are present, the processor adds the competitive processes to a waiting queue.

3. The information processing apparatus according to claim 1, the processor generates exclusion control information indicative of an exclusion state of each of the one or more resources, and controls transition from the first phase to the second phase with reference to the exclusion control information.

4. The information processing apparatus according to claim 3, wherein the exclusion control information related to at least one of a state of referring to the resource, a state of a version of the resource, and a job that has obtained exclusion.

5. The information processing apparatus according to claim 3, wherein the processor controls storing of the exclusion control table into a management database.

6. A non-transitory computer-readable recording medium having stored therein a control program for causing a computer to execute a process comprising:
in an information processing apparatus including one or more resources,
allowing a plurality of processes to be performed on one of the one or more resources to obtain the exclusion in parallel by optimistic locking control in a first phase; and
executing one of the plurality of processes on the resource in a state where the exclusion is obtained by pessimistic locking control in a second phase.

7. The non-transitory computer-readable recording medium according to claim 6, wherein the process further comprises:
in a case where one or more competitive processes with the process executed in the second phase are present, adding the competitive processes to a waiting queue.

8. The non-transitory computer-readable recording medium according to claim 6, wherein the process further comprises:
generating exclusion control information indicative of an exclusion state of each of the one or more resources; and
controlling transition from the first phase to the second phase with reference to the exclusion control information.

9. The non-transitory computer-readable recording medium according to claim 8, wherein the exclusion control information related to at least one of a state of referring to the resource, a state of a version of the resource, and a job that has obtained exclusion.

10. The non-transitory computer-readable recording medium according to claim 8, wherein the process further comprises controlling storing of the exclusion control table into a management database.

11. A method for controlling an information processing apparatus including one or more resources, the method comprising:
at a processor of a computer,
allowing a plurality of processes to be performed on one of the one or more resources to obtain the exclusion in parallel by optimistic locking control in a first phase; and
executing one of the plurality of processes on the resource in a state where the exclusion is obtained by pessimistic locking control in a second phase.

12. The method according to claim 11, further comprising:
at the processor of the computer,
in a case where one or more competitive processes with the process executed in the second phase are present, adding the competitive processes to a waiting queue.

13. The method according to claim 11, further comprising:
at the processor of the computer,
generating exclusion control information indicative of an exclusion state of each of the one or more resources; and
controlling transition from the first phase to the second phase with reference to the exclusion control information.

14. The method according to claim 13, wherein the exclusion control information related to at least one of a state of referring to the resource, a state of a version of the resource, and a job that has obtained exclusion.

15. The method according to claim 13, further comprising:
at the processor of the computer,
controlling storing of the exclusion control table into a management database.
